(19) United States
(12) Patent Application Publication
(10) Pub. No.: US 2023/0206054 A1
(43) Pub. Date: Jun. 29, 2023

(54) Expedited Assessment and Ranking of Model Quality in Machine Learning

(71) Applicant: Luminide, Inc., San Ramon, CA (US)

(72) Inventors: Anil THOMAS, San Ramon, CA (US); Luke HORNOF, Oakland, CA (US); Robert HARRIS, Portland, OR (US)

(73) Assignee: Luminide, Inc., San Ramon, CA (US)

(21) Appl. No.: 17/560,422

(22) Filed: Dec. 23, 2021

(51) Int. Cl. G06N 3/08

(52) U.S. Cl. CPC G06N 3/08

(57) ABSTRACT

The assessment and ranking of machine learning models is sped up. In one embodiment, a plurality of model definitions are automatically tested and ranked according to their expected generalization ability. Other embodiments include assessing a single change to the model to determine if the change increases or decreases the model's generalization ability. This technique can also be applied to assess input data transformations used to develop the model.

### TECHNICAL FIELD

This invention relates to machine learning, in particular, the training of neural networks.

### BACKGROUND OF THE INVENTION

The concept of “artificial intelligence” has gone in a few decades from being an area of primarily academic interest or a theme in science fiction films, to being a part of applications in everyday use. In most cases, this involves the use of techniques of machine learning, of which a neural network is a common example.

A neural network is a series of computing procedures theoretically structured to model the assumed operation of the human brain in that it comprises a number of layers of “nodes” (or “neurons”), with nodes in each layer holding data that is passed as inputs to nodes in the next higher layer, with each node mathematically combining its inputs to form an output, from a lowest input layer, through intermediate “hidden” layers, to a final output layer. Although not strictly necessary, the mathematical combinations are usually weighted linear functions of the inputs, often with an associated threshold such that, if the output of the node is above the threshold, the node is activated, that is, its output is sent to the next higher network layer. The normal goal of a machine learning model such as a neural network is to identify underlying relationships in a set of data.

A neural network is typically trained by entering sets of training data in the lowest level layer and iteratively adjusting the node interconnection weights until the output produced for each set is “correct”, meaning that it corresponds to a known output. Abstractly, machine learning can be viewed as methods to approximate a target function ƒ that maps sets of input variables x to some known output variable Y, that is Y=ƒ(x).

To improve their accuracy, neural networks are “trained”, such that sets of training data having known outputs are presented as inputs to the network, and the network's weights and other model parameters are iteratively updated in order to minimize an objective function on the training datasets. Given the right training datasets, the assumption is that the network will perform well even on unknown input data. In common applications, such as speech, image, and other pattern recognition, sufficient training is highly resource-intensive and time-consuming. Even “efficient” training is highly dependent on which model of the network is meant to implement.

A low training error indicates that the neural network has learned to interpret the training set well, but this does not necessarily mean that the neural network configuration accurately models “reality”. Validation error, on the other hand, indicates the performance of the configured neural network model given known validation data sets as inputs, and is thus also an indication of how well the trained model generalizes, that is, fits to data that it has not been trained on. Note that one generally does not optimize the neural network model for the validation data sets as well because this essentially simply turns the validation data sets into additional training data sets. This can in turn often lead to overfitting, that is, a model that so closely—too closely—models the often noisy training data that its ability to model unseen, real data is degraded. Once the neural network model has been trained to satisfaction, it may be run and evaluated based on completely unseen test data sets.

Data scientists and other practitioners of machine learning therefore strive for generalization ability in their models. This quality determines how well a model performs on new data. A held out set of data called the validation dataset is commonly used to periodically assess a model's generalization ability during training.

During the model development process, changes are made to the model with the goal of improving it, e.g. increasing accuracy. The training process can then assess the impact of each model change and determine if the change increases or decreases the model's generalization ability.

The training process also involves a set of hyperparameters. As used in this disclosure, the term “hyperparameter” includes any configuration setting that can influence the generalization ability of a model. Some hyperparameters such as learning rate, momentum and weight decay govern the optimization process of the model parameters. Some others may define the model architecture, for example, the number of layers in a neural network, the size of convolution kernels, or if attention layers and recurrent layers are used. Both the type as well as the degree of input data transformations used to augment the training dataset may also be guided by hyperparameters.

While the parameters of a model can be optimized by following the gradient of an objective function with respect to each of the parameters, the hyperparameters typically cannot be optimized this way. This is a result of the objective function not being differentiable with respect to the hyperparameters. A process called tuning is therefore employed to find an optimal set of hyperparameters: A number of training sessions are executed with different sets of hyperparameter values, and the set that led to the least error in the validation set is picked as the optimal set.

Known methods such as Bayesian Optimization, can speed up the process of tuning. When the result of a specific training session (hereafter referred to as a “trial”) is available, Bayesian Optimization can intelligently choose the next set of hyperparameters to improve the chances of finding a superior set. While Bayesian Optimization is a major improvement over grid search and random search, it requires that the trials be run to completion. Combined with the fact that the number of combinations of hyperparameters increases exponentially with each extra hyperparameter, the tuning process often becomes prohibitively computationally expensive.

Other known methods such as Successive Halving and Hyperband can speed up Bayesian Optimization by employing early termination of unpromising trials. In practice, however, it is difficult to determine the quality of a model without running a trial to completion. For example, a hyperparameter set that includes a relatively low learning rate is likely to train more slowly, giving the potentially false impression that it is an unpromising trial and leading to early termination. However, the early result in this case may not be indicative of the model's generalization ability if the trial were allowed to run to completion.

This shortcoming of early termination techniques is even more evident when the training dataset is augmented with data transformations. Data augmentation usually leads to a model that can generalize better to varied input data. The training speed however, is negatively impacted as the training set increases in size. This can, once again lead to misjudgment of the quality of hyperparameter sets.

### BRIEF DESCRIPTION OF THE DRAWINGS

FIG. 1 shows the results of two trials of a prototype of the invention, using different hyperparameter sets.

FIG. 2 shows example plots of data collected by a revised training procedure after smoothing.

### DETAILED DESCRIPTION

The invention provides various methods to reduce the computational burden required for the tuning process of machine learning models and thus improve the efficiency of use of the computing system used to perform the tuning. By shortening the compute required to assess the quality of a model definition (including the model, hyperparameter values, and input data transformations), the invention enables the following possibilities:

1) Given a desired level of predictive ability, reduce the time and/or cost to achieve it; and

2) Given a compute budget, improve the predictive ability of a model.

The methods described here make it possible to explore a wider range of model, hyperparameter, and data values. This decreases the compute, time, and cost needed to achieve a desired generalization ability and/or increases the probability of finding a solution closer to the global optimum.

The reduction in required resources is achieved by predicting the outcome of trials without having to run any of them to completion. This enables efficient exploration of the hyperparameter space during model development.

A trial includes the training process, which iteratively updates model parameters to minimize an objective function as well as checking the predictive power of the current model on a validation dataset. Let the target function ƒ(x) represent the outcome (here, the least validation error observed during a trial) of a trial after N epochs. (An “epoch” is the conventional term for a single pass over the entire training dataset.) N is the number of passes over the training data, that is, number of epochs, required to bring the validation error down to a low value, followed by a rise in value as the model begins to overfit to the training data. In typical scenarios, the model may reach its optimal generalization ability within 50 to 100 epochs. Due to the possibility of noisy evaluations, however, and to reduce the likelihood of accepting a local minimum as the global optimum, it is preferable to run the training process past its initially sensed and possibly only local minimum point to be certain that the model has converged to an optimum point, given the set of input values used for the current trial. The input of a trial includes the model, a set of hyperparameter values, and the dataset.

Proxy Function

To avoid having to evaluate an expensive target function, the invention estimates the outcome of a trial with a proxy function \hat{ƒ}(x), which is used to replace ƒ(x) and is less computationally burdensome to evaluate. This proxy function can be described as follows:

\hat{ƒ}(x)=g(h(x),y), where
x is the current set of hyperparameters
h is a function that represents the minimum validation error seen after running the trial to M epochs
M is a number less than N, typically by an order of magnitude
y stands for the features (see below, especially in reference to Table 1) derived from the training and validation error curves observed while h(x) is computed
g is a prediction function that takes as input the output of h and a set of features y

While the output of h is usually a poor representative for the function ƒ, the function g maps the output of h to a better representation of ƒ. Furthermore, both g and h are very inexpensive to evaluate compared to ƒ and as a result, \hat{ƒ}(x) is less expensive to evaluate than ƒ.

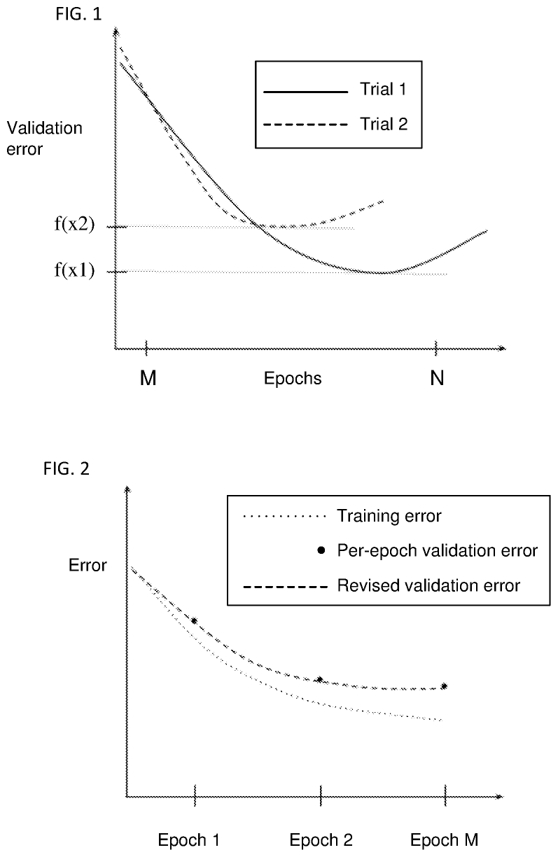

FIG. 1 shows the results of a comparison of two trials, Trial 1 and Trial 2, which use hyperparameter sets x1 and x2 respectively. ƒ(x1) and ƒ(x2) represent the minimum validation errors seen after running both trials to completion. The invention is able to determine that the set x1 is superior to x2 without running either trial to completion, which would require N epochs. The proxy function \hat{ƒ}(x) is evaluated for both trials after running M epochs.

Collecting Data for the Prediction Function

In one embodiment, the prediction function g is constructed by fitting a regression model to data collected during the evaluation of h(x). The training sessions used to collect this data will determine the scenarios in which the prediction function can be used, so varying the set of input values x can collect data that encapsulates a multitude of likely scenarios. Note—all the trials in these training sessions are run to completion so that the actual outcomes given by ƒ(x) are available for corresponding values of h(x) and features y. The prediction function g itself may be chosen to be of any preferred type, including an algebraic function, a machine learning model, a deep learning model, etc.

When the proxy function is used to speed up the tuning process of a new model, the output of the proxy function may differ in magnitude from that of the actual function ƒ(x). This is because the prediction function g is created to generalize to a broad range of scenarios, not specifically the scenario that the new model is faced with. In practice, this does not impact the effectiveness of the proxy function as it is able to arrive at the correct ranking of trials nevertheless. When comparing two trials, the proxy function has been observed to assign a higher rank to the trial that would have been merited by the complete evaluation of ƒ(x).

For example, if three sets of hyperparameter values x1, x2 and x3 are evaluated to result in the ordering ƒ(x1)<ƒ(x2)<ƒ(x3), it also transpires that \hat{ƒ}(x1)<\hat{ƒ}(x2)<\hat{ƒ}(x3). This property enables the method disclosed here to select the optimal set of hyperparameters without resorting to expensive evaluations of function ƒ.

Generating Additional Runtime Data

More accurate prediction functions can be created by generating additional runtime data during the training process. One example would be generating actual data points. Typically, many points are needed on a validation error curve to provide adequate information for an accurate prediction. Prior art methods generate one validation error data point per epoch, at the end of each epoch, which means they require many epochs to obtain sufficient information. In practice, these prior art methods simply look for a point and stop at the point at which they are overfilling, based on the validation error points obtained at the end of epochs, and they make no attempt to fit, for example, a regression model to the data.

Embodiments of this invention, however, obtain a sufficient number of validation error data points from far fewer runs. For example, tests of embodiments of the invention have demonstrated an ability to obtain sufficient data points for fitting a regression model, in as few as three runs.

The general method for generating additional runtime data used in embodiments of the invention proceeds as follows:

1) Run a training session to completion. This involves processing the training dataset, minibatch by minibatch. As is generally known in the field of machine learning, a minibatch consists of multiple data inputs (for example, images) and corresponding labels. Validation is also performed as part of the training process.

2) Record training and validation errors for each minibatch during the training session.

3) Record the actual outcome of the trial, ƒ(x) given by the least validation error observed. Note that, in the context of this invention, “loss” (for example, in the naming of features) means the same thing as “error”.

4) Derive features y from the recorded training errors and validation errors.

5) Fit a regression model based on y and ƒ(x). This regression model then serves as the prediction function g. When the prediction function g is used for ranking, trials are run partially and features are collected from each partial run. Using those features as inputs into the function g then produces \hat{ƒ}(x).

The method described herein may use a wide variety of features y during each trial, many of which are mentioned below by way of example. These features are thus collected for constructing the prediction function g, as well as applying g to map the output of h to the proxy function \hat{ƒ}(x). The features y are derived from any runtime data generated during the training process, such as the per-minibatch data from a typical training process. Optimization algorithms such as gradient descent process the data in “minibatches”, where each minibatch comprises a plurality of data examples. The model parameters are then updated after each minibatch is processed. This implies that error values on the training minibatches are available during a normal training session. However, validation minibatches will typically be processed infrequently, usually after each epoch of training has been completed.

The following pseudocode illustrates the procedure embodiments follow to collect validation error values more frequently:

validation-interval=length(training-set) DIV length(validation-set)

FOR training-minibatch-index=1TO length(training-set)
train(training-minibatch-index)
IF training-minibatch-index MOD validation-interval equals zero
   validate(validation-minibatch-index)
   advance(validation-minibatch-index)

In the pseudocode above, DIV and MOD stand for division and modulus operators. The function train( ) performs both forward and backward propagation. Forward propagation involves passing a minibatch from the training dataset through the network to compute its output. Backward propagation involves computing the differences (error) between the network output and the actual targets (aka ground truth), computing the gradients of this error with respect to the model parameters and then updating the model parameters to bring the error down. The function validate( ) on the other hand only performs forward propagation of a minibatch from the validation dataset and then computes the difference between the network output and the ground truth.

This is the inner loop of the training process and represents the processing within a single epoch. Each time train( ) and validate( ) functions are called, they produce error values on input minibatches. During each call, the model parameters are likely to be different as they continually evolve in each iteration of the loop.

As the pseudocode shows, data sets are divided into multiple “minibatches”, the size of which is determined by a validation interval chosen, for example, as the ratio between the length of the training set and the length of the validation set. Note that although it would typically be inefficient, it would be possible for a minibatch to comprise a single data example. Rather than waiting until the end of each epoch to generate a single validation error value, multiple validation error values are thus obtained for each epoch.

FIG. 2 shows example plots of data collected by the revised training procedure after smoothing has been applied. A point along the training error curve is produced only each time the IF conditional is satisfied, that is, less often, but at regular intervals. This interval is determined by the relative size of the validation set to the training set.

Reducing Noise

The inputs to the prediction function g are produced from the data points thus collected. The input h(x) is directly given by the minimum validation error seen during M epochs. The other features (called y earlier) are derived from both the observed curves. As the evaluated data points tend to be noisy, both the curves may be denoised by a two-step process:

1) Compute the exponentially weighted moving average over a rolling window of predefined size.

2) Apply an expanding transformation to the output of step 1 that averages all the values available up to each point.

Regression Features

Features are derived from the error curves described earlier, optionally smoothened. Some of them may be based on individual curves while others may be based on interactions between them. Example features include the gradients of each curve and the ratios between them. A list of examples of features that were found by experiment to have meaningful predictive power is given in the following Table 1:

TABLE 1

| Feature name | Description |
|---|---|
| train_loss | Training error |
| train_loss_grad | First order gradient of the training error curve |
| train_loss_grad_max | Maximum value of the first order gradient of the |
| | training error curve up to a given point |
| train_loss_min | Minimum value of the first order gradient of the |
| | training error curve up to a given point |
| train_loss_mean | Mean of training error up to a given point |
| train_loss_mean_sq | Squared mean of training error up to a given point |
| val_loss | Validation error |
| val_loss_grad | First order gradient of the validation error curve |
| val_loss_grad_max | Maximum value of the first order gradient of the |
| | validation error curve up to a given point |
| val_loss_min | Minimum value of the first order gradient of the |
| | validation error curve up to a given point |
| val_loss_mean | Mean of validation error up to a given point |
| val_loss_mean_sq | Squared mean of validation error up to a given point |
| val_loss_sec | Second order gradient of the validation error curve |
| val_loss_std | Standard deviation of validation error up to a given point |
| ratio | Ratio of training error to validation error |
| ratio2 | Ratio of validation error to training error |
| divergence | Ratio of the difference between training error and |
| | validation error to the validation error |
| divergence2 | Ratio of the difference between training error and |
| | validation error to the training error |

Each of the above features consists of a sequence of values, with each value corresponding to an iteration of the training loop. The feature values from initial iterations have no predictive value as they are noisy because of the model being largely untrained at that point. During the first epoch, the model encounters every minibatch for the first time and subsequently the difference between training and validation minibatches is not apparent. For these reasons, the data from the first epoch are preferably not used in training or inference.

Constructing the Prediction Function

For training a model that learns the prediction function g, the sequential data may be converted to a table of the form shown here in Table 2:

TABLE 2

| Regression Features | | | | | Regression Target |
|---|---|---|---|---|---|
| Iteration index | h(x) | y | | | f(x) |
| n | Minimum validation | train_loss[n] | train_loss_grad[n] | . . . | Minimum validation |
| | error after M epochs | | | | error after N epochs |
| n + 1 | Minimum validation | train_loss[n + 1] | train_loss_grad[n + 1] | . . . | Minimum validation |
| | error after M epochs | | | | error after N epochs |
| . . . | | | | | |

Table 2 gives an example of a format of input features and targets that may be used to fit a regression model for the prediction function. For brevity, only two of the features are shown. Examples of other features are shown in Table 1. As known, in the area of machine learning, regression learning techniques are used to predict continuous values, with the goal of finding a best-fit line or a curve between given data.

For each row, the feature sequences are indexed with the iteration index corresponding to that row. While the columns h(x) and ƒ(x) are constants for the entire table, a plurality of such tables may be constructed by running multiple trials with varying x. Both h(x) and ƒ(x) are likely to vary across trials. A regression model, such as a neural network, a random forest or a gradient-boosted decision tree may be fitted to the training data. Training data for this regression model is collected from trials involving multiple representative tasks dealing with multiple datasets to ensure that the model generalizes to a broad range of new tasks and datasets. As a result, this trained model can be used to evaluate the proxy function for a trial that uses a different model trained for a different task. Here, “task” is used to mean “problem type” or “application”, a few non-limiting examples of which include computer vision, speech recognition, time-series forecasting and natural language processing (NLP).

Tuning of Models

In one embodiment, the above methods are used to automate the model tuning process. In this case, a Bayesian Optimizer may be used to recommend the next set of hyperparameters to try. In order to get a recommendation, the Bayesian Optimizer must be fed the outcome of an evaluation. Instead of determining the outcome of the target function ƒ(x) by running a trial to completion, a proxy function \hat{ƒ}(x) is evaluated as described in the previous sections and the result is passed to the Bayesian Optimizer.

In another embodiment, the proxy function \hat{ƒ}(x) can be evaluated to provide feedback to the model developer relating to any change made to the model definition. The model developer can use the result of evaluating the relatively inexpensive proxy function to decide whether to keep or discard the change. For example, such changes may include usage of a different neural network architecture, addition of a specific type of layer to the architecture or employing data transformations to augment the training data. Thus, the output of the proxy function from a plurality of trials using different hyperparameter sets as inputs can be compared and an optimal set selected, either manually by a user, or using an automated process.

The expedited assessment method described herein does not preclude the usage of other techniques mentioned in the Background section that rely on early termination. It is possible to use this method in conjunction with other methods such as Hyperband in order to gain additional resource optimization.

1. A machine learning method comprising:
configuring a model according to a set of hyperparameters;
training the model to identify a relationship in a training dataset by inputting the set of training data into the model in a series of passes in at least one trial; and
constructing and executing a proxy function that approximates a target function that indicates a generalization ability of the trained model.

2. The method of claim 1, in which the model is a neural network.

3. The method of claim 1, further comprising carrying out a plurality of the trials having different input hyperparameters and identifying an optimal set of the hyperparameters.

4. The method of claim 1, in which the target function represents a least validation error after N epochs, further comprising:
running the model for M epochs, where M is less than N;
determining a minimum validation error after running the model for the M epochs; and
applying the proxy function as a prediction function of the determined minimum validation error and at least one feature.

5. The method of claim 1, further comprising:
selecting representative tasks for the model and running a plurality of training sessions for each task to completion;
sampling validation error values periodically along with training error values;
determining validation and training error curves from the training sessions;
deriving features from the validation and training error curves; and
fitting a regression model with the derived features as inputs and the minimum validation error values as labels.

6. The method of claim 5, further comprising denoising the training and validation error curves.

7. The method of claim 5, in which the at least one feature is chosen from a group including:
a training error;
a first-order gradient of a training error curve;
a maximum value of the first order gradient of the training error curve up to a first given point;
a minimum value of the first order gradient of the training error curve up to a second given point;
a mean of training error up to a third given point;
a squared mean of the training error up to a fourth given point;
a validation error value;
a first-order gradient of the validation error curve;
a maximum value of the first-order gradient of the validation error curve up to a fifth given point;
a minimum value of the first order gradient of the validation error curve up to a sixth given point;
a mean of validation error up to a seventh given point;
a squared mean of validation error up to an eighth given point;
a second-order gradient of the validation error curve;
a standard deviation of validation error up to a ninth given point;
a ratio of training error to validation error;
a ratio of validation error to training error;
a ratio of the difference between training error and validation error to the validation error; and
a ratio of the difference between training error and validation error to the training error.

8. The method of claim 1, further comprising:
running a machine learning training session to completion, including processing the training dataset in minibatches;
determining training and validation errors for each minibatch during the training session;
determining an actual outcome of the trial according to a least observed validation error;
deriving features y from recorded training errors and validation errors; and
fitting a regression model according to the derived features and actual outcome, the regression model thereby comprising a prediction function.

9. The method of claim 8, comprising:
partially running a plurality of the trials;
deriving respective sets of the features from each partially run trial;
applying the proxy function according to an output of the prediction function with the sets of features as inputs; and
ranking the trials according to the prediction function.

10. The method of claim 9, further comprising:
determining an optimum point of the proxy function; and
adjusting the hyperparameters of the model according to the optimum point.
